(19) United States
(12) Patent Application Publication
(10) Pub. No.: US 2009/0045653 A1
(43) Pub. Date: Feb. 19, 2009

(54) WIRE ROPE HARNESS BACKBONE

(75) Inventors: Allen R. Wittman, Convoy, OH (US); Rodney N. Germann, Payne, OH (US)

Correspondence Address: International Truck Intellectual Property Company,, 4201 WINFIELD ROAD, WARRENVILLE, IL, 60555, US

(73) Assignee: International Truck Intellectual Property Company, LLC, Warrenville, IL (US)

(21) Appl. No.: 11/837,711

(22) Filed: Aug. 13, 2007

(51) Int. Cl. B60R 16/00

(52) U.S. Cl. 296/203.01; 242/147 R

(57) ABSTRACT

A vehicle is provided having a flexible linear member such as an electrical harness and a tensioned guide such as a wire rope to which the electrical harness is attached. This provides a well supported, direct, and secure routing that eliminates the need for extensive bracketry. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### BACKGROUND

It is necessary in the manufacture of a vehicle having electrical systems to provide secure routing for the bundles of wires, known collectively as an electrical harness, that comprise those electrical systems. The electrical harness must be supported at least at certain maximum intervals along its length in order to minimize tension in the harness and prevent it from contacting certain other vehicle components. In the case of trucks and busses, which have ladder-type vehicle frames, the electrical harness is commonly supported by small stand-off brackets to which it is attached by means of P-clips. Each stand-off bracket must be individually fastened to the vehicle frame, commonly by at least two fasteners, requiring mating holes to be provided in the frame. The P-clips must be installed around the electrical harness, and then fastened to the stand-off brackets.

Alternatives to the stand-off bracket and P-clip arrangements exist, such as molded plastic clips that are directly attachable to the vehicle frame and are provided with one or more zip-tie type devices, or provisions to attach such zip-tie type devices. In the case of both the P-clip and standoff arrangement and the molded plastic clip arrangement, the electrical harness must be routed in relatively close proximity to the structures that make up the vehicle frame. Often, this results in convoluted routing of the electrical harness, sometimes requiring that the electrical harness be passed through openings in the crossmembers of the vehicle frame, which necessitates a tedious and inefficient process of assembling the vehicle.

Similar problems exist in the routing of pneumatic brake lines, hydraulic brake lines, hydraulic hoses, heater hoses, brake cables, actuator cables, electrical cables, and other such flexible linear members. Just like the electrical harness, these other types of flexible linear members must be securely supported at least at certain maximum intervals, in order to limit tension in the flexible linear members, and to prevent them from coming into contact with certain other vehicle components. Again, this often results in convoluted routing of the flexible linear members.

A more desirable routing would involve passing these flexible linear members directly along the top of the vehicle frame, in between the sidemembers of the frame and above the frame crossmembers. As the construction method of trucks and busses commonly involves building the frame and running gear, and then attaching the body assembly or assemblies to the frame, the area directly above the frame and below the body is relatively well-protected from abrasion and debris. Alternately, it may be desirable to route certain flexible linear members directly along the outside of the vehicle frame, or even beneath it.

A problem heretofore inherent in routing the flexible linear members directly along the top of the vehicle frame was the lack of support for the flexible linear members in the space between crossmembers. The only solution that has been available has been to route the flexible linear member to a location nearer one of the frame rails for support, requiring additional and expensive flexible linear member length, or to provide substantial bracketry to support the flexible linear member in between the crossmembers. Even when routing certain flexible linear members along the outside of the vehicle frame or beneath it, numerous support brackets may be required in order to limit tension in the flexible linear members.

### SUMMARY

It is advantageous in the design and construction of vehicles having an electrical harness to provide routing for the electrical harness that is as direct as possible, secure from abrasive contact with other vehicle components and sharp edges, and free from the encumbrance of having to pass through holes in crossmembers or other vehicle components. It is further advantageous that any bracketry that may need to be provided in order to support the electrical harness be as simple, lightweight, and inexpensive as possible. In the same way, it is advantageous to route other types of flexible linear members as directly as possible, using a minimum of bracketry and assembly operations.

One embodiment of the present invention solves the problems of the prior art by providing a tensioned guide and support in the form of a wire rope or cable, to which the electrical harness or other flexible linear member is attached. An embodiment of the present invention, for example, may have the tensioned wire rope guide attached to the vehicle frame at points proximate to the ends of the frame. One of the attached ends of the tensioned wire rope guide may be simply attached to an eye-bolt, while the other end of the tensioned wire rope guide may be provided with a spring-loaded tensioning device, in order to accommodate stretch and temperature expansion in the tensioned wire rope guide. The tensioned wire rope guide may be threaded along the top of the vehicle frame through eye-bolts at each crossmember, and may even be guided around obstacles by the eye-bolts. The electrical harness or other flexible linear member may be attached to the tensioned wire rope guide by means of wire ties or their equivalent.

An alternate embodiment of the present invention may use another form of tensioned guide, such as a polymer cord or braid. In another embodiment, the tensioned guide may be attached to the vehicle frame at points proximate to the ends of the frame, and may be threaded along the side or bottom of the vehicle frame through eye-bolts attached to the frame or to each crossmember. Again, the tensioned guide may be threaded around obstacles by means of the eye-bolts. In yet another embodiment, the tensioned guide may not be attached to the vehicle frame at all, but may instead be attached to one or more other vehicle components, such as the vehicle body or engine.

### BRIEF DESCRIPTION OF THE DRAWINGS

FIG. 1—Vehicle having a frame and a flexible linear member having convoluted routing.

FIG. 2—An embodiment of the present invention: a vehicle having a frame and a flexible linear member with a tensioned guide.

FIG. 3—An embodiment of the present invention: a frame, crossmembers, and tensioned guide.

FIG. 4—A spring loaded tensioning device.

FIG. 5—Multiple embodiments of the present invention on a vehicle.

FIG. 6—An embodiment of the present invention: a vehicle having a frame and subcomponents, with flexible linear member attached to a tensioned guide.

### DETAILED DESCRIPTION OF THE INVENTION

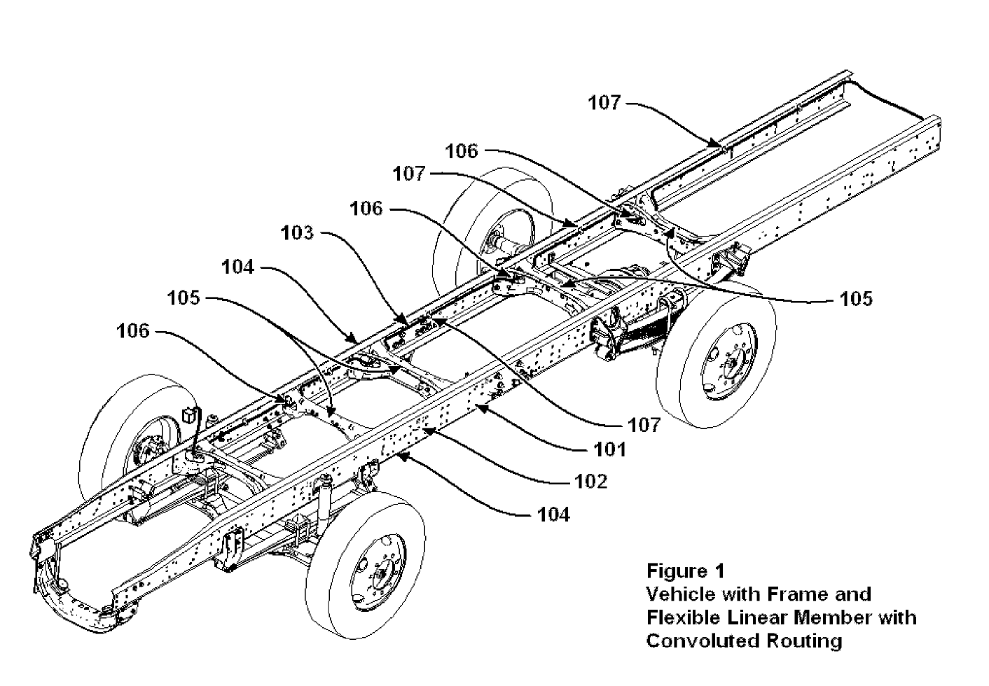

FIG. 1 shows a vehicle 101 having a frame 102 and a flexible linear member 103 having convoluted routing as is common in the prior art. The flexible linear member 103 shown in FIG. 1 is shown as an electrical harness, but it may as well be a pneumatic brake line, hydraulic brake line, hydraulic hose, heater hose, brake cable, actuator cable, or electrical cable. As is common, the frame 102 of the vehicle 101 has side rails 104 and multiple crossmembers 105, which multiple crossmembers 105 present an obstacle to the direct routing of the flexible linear member 103 along the inside of the side rails 104. In this case, the flexible linear member 103 is routed through openings 106 in the crossmembers 105, and is attached to both the side rails 104 and the crossmembers 105 by means of P-clips 107. Due to the convoluted nature of the routing of the flexible linear member 103, it is longer, more costly, and more tedious to attach to the vehicle 101.

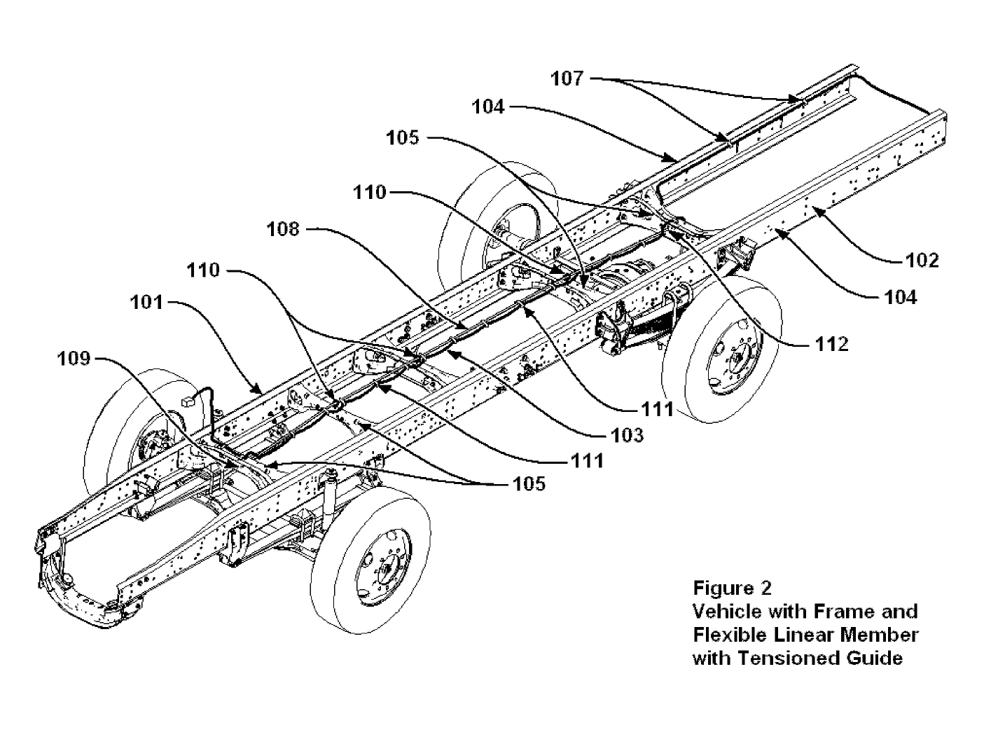

FIG. 2 shows a vehicle 101 having a frame 102 comprised of side rails 104 and multiple crossmembers 105, similar to the vehicle 101 shown in FIG. 1. An embodiment of the present invention, a tensioned guide 108, is attached to the crossmembers 105 such that one end of the tensioned guide 108 is attached to a crossmember 105 proximate to the forward end of the frame 102 by means of a front anchorage 109, and the other end of the tensioned guide 108 is attached to a crossmember 105 proximate to the rearward end of the frame 102 by means of a rear anchorage 112. Sufficient tension is placed upon the tensioned guide 108 that the tensioned guide 108 is relatively rigid along its length and able to provide support over the distance between the crossmembers 105. The tensioned guide 108 is held in place at the top of several crossmembers 105 by means of eyebolts 110. The flexible linear member 103 is attached to the tensioned guide 108 by wire-tie devices 111 such as zip-ties or their equivalent. The flexible linear member 103 may further be attached to the side rails 104 of the frame 102 by means of P-clips 107 in areas of the frame 102 extending beyond the first or last crossmembers 105. As mentioned previously, the flexible linear member 103 shown in FIG. 2 is shown as an electrical harness, but it may as well be a pneumatic brake line, hydraulic brake line, hydraulic hose, heater hose, brake cable, actuator cable, or electrical cable.

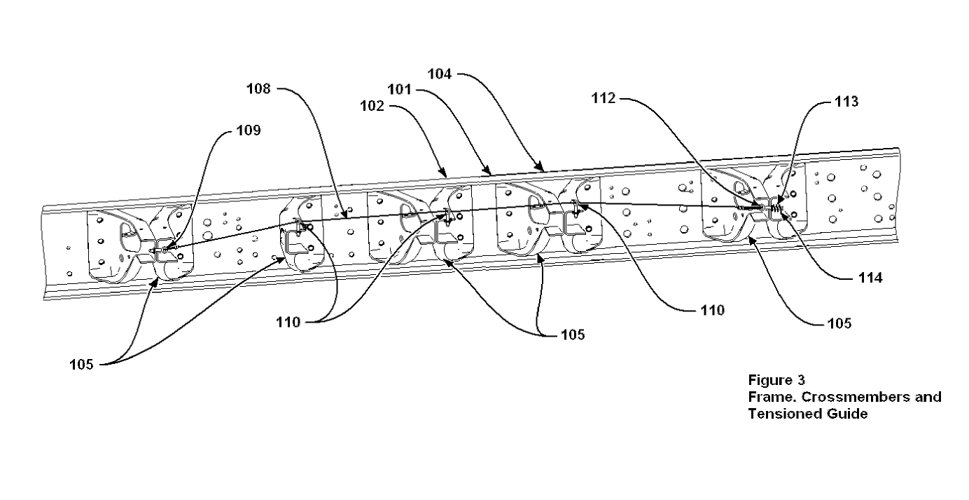

FIG. 3 shows the frame 102 of a vehicle 101, again comprised of side rails 104 and multiple crossmembers 105, similar to the frames 102 of vehicles 101 shown in FIGS. 1 and 2. In the case of the frame 102 of the vehicle 101 shown in FIG. 3, the frame 102 is shown truncated and considerably compressed in length, such that crossmembers 105 that would be separated by a distance are shown close together. Also, the frame 102 is shown sectioned along the long axis, such that the multiple crossmembers 105 are shown cut approximately in half. A tensioned guide 108 extends from a front anchorage 109 to a rear anchorage 112, and passes through eyebolts 110 attached to the multiple crossmembers 105. For the sake of clarity, the flexible linear member 103, be it an electrical harness, pneumatic brake line, hydraulic brake line, hydraulic hose, heater hose, brake cable, actuator cable, or electrical cable, is not shown in FIG. 3. It may be appreciated that the flexible linear member 103 (not shown) attaches to the tensioned guide 108 shown in FIG. 3 in a manner similar to that shown in FIG. 2. The front anchorage 109 in FIG. 3 is shown as a typical eye-bolt, although an equivalent anchorage of another form may be used. The rear anchorage 112 is provided with a spring-loaded tensioning device 113. The tensioning device 113 shown in FIG. 3 is shown as an eye-bolt with a coil spring 114. Another embodiment of the invention may use both non-spring-loaded anchorages with a spring-loaded tensioning device incorporated into the tensioned guide 108 itself. Another embodiment of the invention may use standard eye-bolts as both front and rear anchorages, and rely upon the threaded shank of the eye-bolts for passive tensioning.

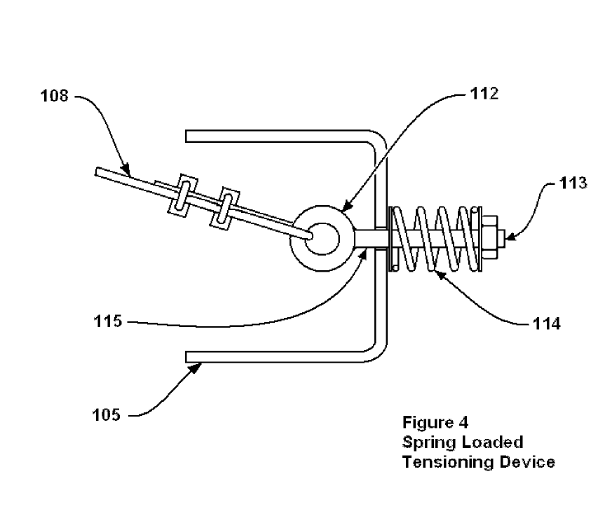

FIG. 4 shows a cross-section of a crossmember 105 and the rear anchorage 112 as a spring-loaded tensioning device 113. The spring-loaded tensioning device 113 embodiment of the rear anchorage 112 is comprised of an anchorage sliding member 115 and a coil spring 114. The tensioned guide 108 is attached to the anchorage sliding member 115 in conventional manner, and the coil spring 114 exerts force against the backside of the crossmember 105, such that the spring-loaded tensioning device 113 pulls on the tensioned guide 108 while accommodating stretch and expansion and contraction in the tensioned guide 108. Note that the rear anchorage 112 is shown as a spring-loaded tensioning device 113, whereas it is within the scope of the invention that the front anchorage 109 (not shown) may be instead provided as a spring-loaded tensioning device 113, or both the front anchorage 109 (not shown) and the rear anchorage 112 may be provided as spring-loaded tensioning devices 113.

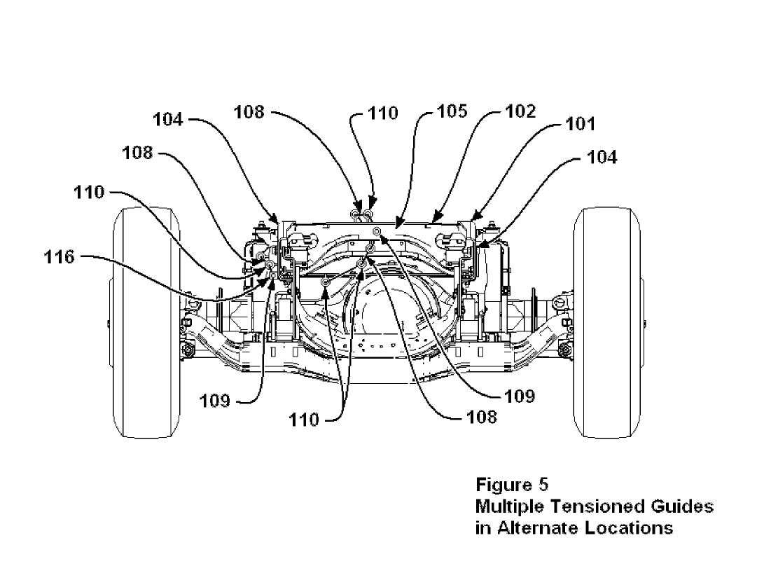

FIG. 5 shows multiple embodiments of the present invention on a vehicle 101. As in previous figures, the vehicle 101 in FIG. 5 has a frame 102 comprised of side rails 104 and multiple crossmembers 105. Three tensioned guides 108 are shown in alternate locations upon the frame 102. For the sake of clarity, the flexible linear member 103, be it an electrical harness, pneumatic brake line, hydraulic brake line, hydraulic hose, heater hose, brake cable, actuator cable, or electrical cable, is not shown in FIG. 5. It may again be appreciated that the flexible linear member 103 (not shown) attaches to the tensioned guide 108 shown in FIG. 3 in a manner similar to that shown in FIG. 2. One tensioned guide 108 passes along the top side of the frame 102, with the front anchorage 109, rear anchorage 112 (not visible), and eyebolts 110 attached to successive crossmembers 105. Another tensioned guide 108 passes along the bottom side of the frame 102, again with the front anchorage 109, rear anchorage 112 (not visible), and eyebolts 110 attached to successive crossmembers 105. Yet another tensioned guide 108 passes along the side of the frame 102, with the eyebolts 110 attached to the sides of the side rails 104, and the front anchorage 109 and rear anchorage 112 (not visible) attached to small anchorage brackets 116.

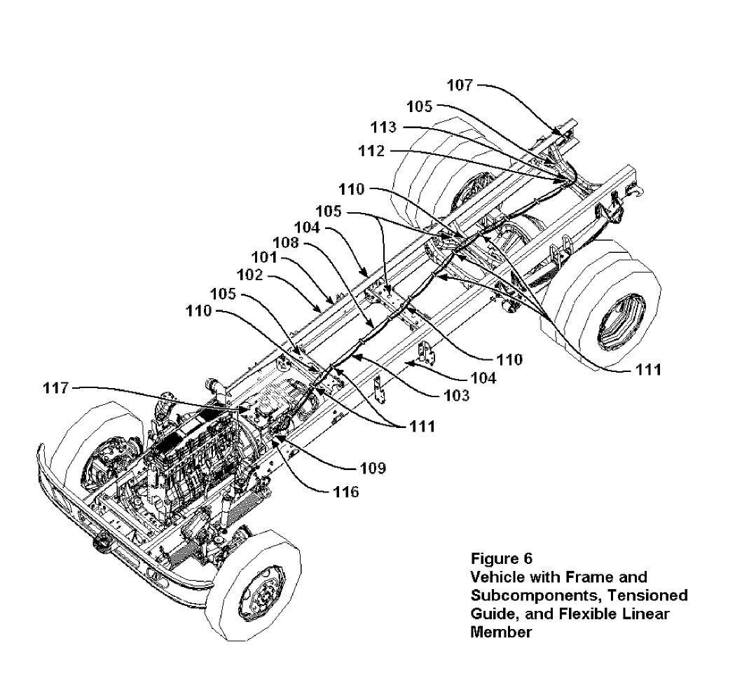

FIG. 6 shows an embodiment of the present invention on a vehicle 101 having a frame 102 comprised of side rails 104 and multiple crossmembers 105, similar to the vehicles 101 shown in FIGS. 1, 2, 3, and 5. In addition to the frame 102, the vehicle 101 is provided with at least one vehicle subcomponent 117, shown in FIG. 6 as an engine and transmission assembly. A tensioned guide 108 extends from a front anchorage 109, which front anchorage 109 is attached to the at least one vehicle subcomponent 117 by means of a small anchorage bracket 116, to a rear anchorage 112, and passes through eyebolts 110 attached to multiple crossmembers 105. A flexible linear member 103 is attached to the tensioned guide 108 by wire-tie devices 111 such as zip-ties or their equivalent. The flexible linear member 103 shown in FIG. 6 is shown as an electrical harness, but it may as well be a pneumatic brake line, hydraulic brake line, hydraulic hose, heater hose, brake cable, actuator cable, or electrical cable. The flexible linear member 103 may further be attached to the side rails 104 of the frame 102, or to the at least one vehicle subcomponent 117, by means of P-clips 107 in areas extending beyond the front anchorage 109 and rear anchorage 112. Either the front anchorage 109 or the rear anchorage 112, or both, may be provided with a spring loaded tensioning device 113. It is also within the scope of the invention that the front anchorage 109 be attached to the frame 102, with the rear anchorage 112 attached to a vehicle subcomponent 117, or that both the front anchorage 109 and the rear anchorage 112 be attached to vehicle subcomponents 117. Further, it is within the scope of the invention that one or more of the eyebolts 110 be attached to one or more vehicle subcomponents 117.

While specific embodiments have been described in detail in the foregoing detailed description and illustrated in the accompanying drawings, those with ordinary skill in the art will appreciate that various permutations of the invention are possible without departing from the teachings disclosed herein. Accordingly, the particular arrangements disclosed are meant to be illustrative only and not limiting as to the scope of the invention, which is to be given the full breadth of the appended claims and any and all equivalents thereof. Other advantages to a vehicle having a flexible linear member attached to a tensioned guide may also be inherent in the invention, without having been described above.

I claim:

1. A vehicle for operation on the ground, comprising:
a frame;
at least two anchorages attached to said frame;
a tensioned guide attached to said at least two anchorages; and
a flexible linear member attached to said tensioned guide.

2. The vehicle for operation on the ground of claim 1, wherein:
said flexible linear member further comprises an electrical harness.

3. The vehicle for operation on the ground of claim 1, wherein:
said flexible linear member further comprises at least one tube for conducting fluid.

4. The vehicle for operation on the ground of claim 1, wherein:
said flexible linear member further comprises at least one cable for conducting motion.

5. The vehicle for operation on the ground of claim 1, wherein:
said flexible linear member further comprises at least one electrical cable.

6. The vehicle for operation on the ground of claim 1, wherein:
said tensioned guide further comprises wire rope.

7. The vehicle for operation on the ground of claim 1, wherein:
said tensioned guide further comprises polymer cord.

8. The vehicle for operation on the ground of claim 1, wherein:
at least one of said at least two anchorages further comprise a spring-loaded tensioning device.

9. The vehicle for operation on the ground of claim 1, wherein:
said tensioned guide incorporates a spring-loaded tensioning device.

10. The vehicle for operation on the ground of claim 1, wherein:
said frame further comprises at least two side rails and at least one crossmember;
at least one eyebolt is attached to said at least one crossmember; and
said tensioned guide passes through said at least one eyebolt.

11. The vehicle for operation on the ground of claim 1, wherein:
said flexible linear member is attached to said tensioned guide by at least one wire-tie device.

12. The vehicle for operation on the ground of claim 1, wherein:
said tensioned guide and said attached flexible linear member pass along the top of said frame.

13. The vehicle for operation on the ground of claim 1, wherein:
said tensioned guide and said attached flexible linear member pass along the bottom of said frame.

14. The vehicle for operation on the ground of claim 1, wherein:
said tensioned guide and said attached flexible linear member pass along the side of said frame.

15. A vehicle for operation on the ground, comprising:
a frame;
at least one vehicle subcomponent attached to said frame;
at least two anchorages, at least one of said at least two anchorages attached to said at least one vehicle subcomponent;
a tensioned guide attached to said at least two anchorages; and
a flexible linear member attached to said tensioned guide.

16. The vehicle for operation on the ground of claim 15, wherein:
said flexible linear member further comprises an electrical harness.

17. The vehicle for operation on the ground of claim 15, wherein:
said flexible linear member further comprises at least one tube for conducting fluid.

18. The vehicle for operation on the ground of claim 15, wherein:
said flexible linear member further comprises at least one cable for conducting motion.

19. The vehicle for operation on the ground of claim 15, wherein:
said flexible linear member further comprises at least one electrical cable.

20. The vehicle for operation on the ground of claim 15, wherein:
said tensioned guide further comprises wire rope.
